(19) United States
(12) Patent Application Publication
(10) Pub. No.: US 2024/0361772 A1
(43) Pub. Date: Oct. 31, 2024

(54) AMELIORATING RISK TO AN UNMANNED AERIAL VEHICLE

(71) Applicant: International Business Machines Corporation, Armonk, NY (US)

(72) Inventors: Zachary A. Silverstein, Georgetown, TX (US); Melanie Dauber, Oceanside, NY (US); Jeremy R. Fox, Georgetown, TX (US); Jacob Ryan Jepperson, St. Paul, MN (US); Logan Bailey, Atlanta, GA (US)

(21) Appl. No.: 18/307,223

(22) Filed: Apr. 26, 2023

(51) Int. Cl. G05D 1/06; G06Q 10/20; G06Q 50/28

(52) U.S. Cl. CPC G05D 1/0688; G06Q 10/08; G06Q 10/20; B64D 2045/008

(57) ABSTRACT

In an approach to ameliorating risk to an unmanned aerial vehicle, a computer retrieves valuation data corresponding to one or more components of an unmanned aerial vehicle. A computer detects a flight failure scenario of the unmanned aerial vehicle. A computer prioritizes a flight remediation pattern of the unmanned aerial vehicle. A computer identifies a feasibility of flight recovery. Based on the feasibility of the flight recovery, a computer determines flight capacity is lost. A computer retrieves risk calculation data. A computer calculates a damage risk for each of the one or more components using the risk calculation data. Based on the retrieved valuation data and the calculated damage risk, a computer ranks the damage risk for each of the one or more components. Based on the ranking, a computer modifies one or more movement factors of the unmanned aerial vehicle to alleviate damage.

### BACKGROUND OF THE INVENTION

The present invention relates generally to the field of unmanned aerial vehicles, and more particularly to ameliorating risk to an unmanned aerial vehicle.

An unmanned aerial vehicle (UAV), commonly known as a drone, is an aircraft without a human pilot aboard. Flight of the UAV is controlled either autonomously by onboard computers or by a remote control operated by a pilot or system on the ground. The typical launch and recovery method of an unmanned aircraft is by the function of an automatic system or an external operator on the ground. As control technologies have improved and costs continue to fall, the use of UAVs has expanded to include aerial photography, precision agriculture, forest fire monitoring, river monitoring, environmental monitoring, infrastructure inspections, product deliveries, and entertainment.

### SUMMARY

Embodiments of the present invention disclose a computer-implemented method, a computer program product, and a system for ameliorating risk to an unmanned aerial vehicle. The computer-implemented method may include a computer retrieving valuation data corresponding to one or more components of an unmanned aerial vehicle. A computer detects a flight failure scenario of the unmanned aerial vehicle. A computer prioritizes a flight remediation pattern of the unmanned aerial vehicle. A computer identifies a feasibility of flight recovery. Based on the feasibility of the flight recovery, a computer determines flight capacity is lost. A computer retrieves risk calculation data. A computer calculates a damage risk for each of the one or more components using the risk calculation data. Based on the retrieved valuation data and the calculated damage risk, a computer ranks the damage risk for each of the one or more components. Based on the ranking, a computer modifies one or more movement factors of the unmanned aerial vehicle to alleviate damage.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of an unmanned aerial vehicle (UAV) protection program, on a UAV within the distributed data processing environment of FIG. 1, for ameliorating risk to the UAV, in accordance with an embodiment of the present invention; and

FIG. 3 illustrates an exemplary computer environment in which aspects of one or more of the illustrative embodiments may be implemented, and at least some of the computer code involved in performing the inventive methods may be executed, in accordance with an embodiment of the present invention.

### DETAILED DESCRIPTION

Unmanned aerial vehicles (UAVs), i.e., drones, are becoming popular in both a consumer and a commercial sense. If a UAV encounters a failure scenario that causes the UAV to crash, then the peripheral components of the UAV, many of which may be expensive to replace, may be damaged. Embodiments of the present invention recognize that improvements to UAV technology may be made by providing a system that enables a UAV to ameliorate its failure pattern and flight controls to preserve peripheral component health based on prioritization. Embodiments of the present invention recognize that protection of the most valuable parts of a UAV, whether the valuation is based on cost to replace or on priority to preserve, may be achieved by enabling the UAV to quickly respond to an imminent accident by executing actions to modify crash behavior. Embodiments of the present invention also recognize that protection of any cargo or payload that the UAV is carrying may require prioritization over the peripheral components of the UAV. Implementation of embodiments of the invention may take a variety of forms, and exemplary implementation details are discussed subsequently with reference to the Figures.

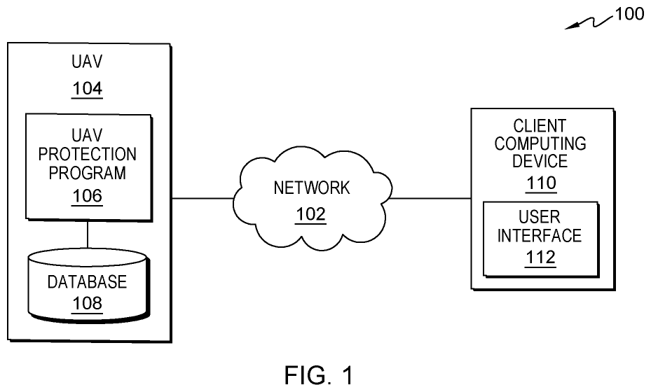

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

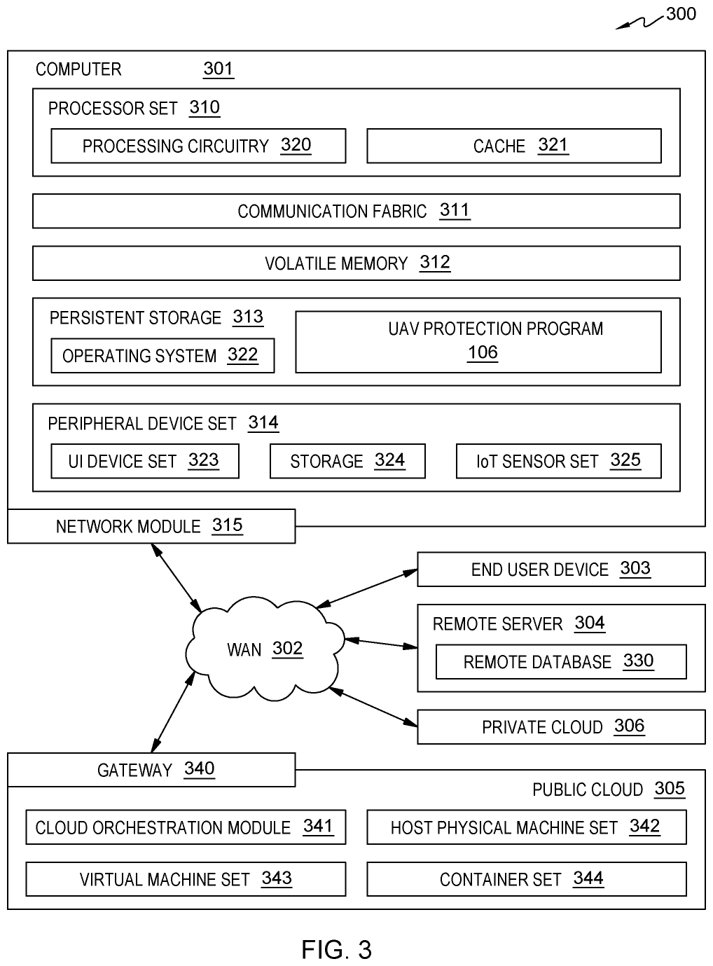

Distributed data processing environment 100 includes UAV 104 and client computing device 110 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between UAV 104, client computing device 110, and other computing devices (not shown) within distributed data processing environment 100. Distributed data processing environment 100 may be implemented in computing environment 300, shown in FIG. 3.

UAV 104 is an unmanned aerial vehicle that can be deployed to capture images, deliver packages, and other various activities, both currently known and those deployed in the future. UAV 104 may take one of a plurality of forms, for example, an airplane, a helicopter, or a projectile. In an embodiment, UAV 104 may be another type of vehicle, such as an unmanned, or autonomous, ground vehicle. UAV 104 includes the capability of any programmable electronic device or combination of programmable electronic devices capable of executing machine readable program instructions and communicating with other computing devices via a network, such as network 102. In one embodiment, UAV 104 also includes a plurality of sensors (not shown) used to monitor environmental conditions, for example, cameras, radar, infrared, etc. In an embodiment, UAV 104 includes a plurality of sensors (not shown) to detect weather conditions, such as air temperature, relative humidity, presence and type of precipitation, wind speed, etc. In an embodiment, UAV 104 includes a plurality of sensors (not shown) such as a laser sensor configured to measure the distance between objects, an altimeter to measure altitude, a gyroscope (e.g., to measure movement changes indicative of changes in terrain), and a compass or other indicator of magnetic field which can be used, for example, for navigation and/or measuring magnetic field variability in geology. In an embodiment, UAV 104 includes a plurality of sensors (not shown) to detect the health of various peripheral components of UAV 104, such as metrics associated with the functioning of the components. In some embodiments, UAV 104 also includes systems for communication, for example, Bluetooth, and navigation, for example, a global positioning system (GPS), as well as additional mapping and object recognition systems (not shown). In the depicted embodiment, UAV 104 includes UAV protection program 106 and database 108.

UAV protection program 106 detects a potential failure state of UAV 104 and modifies a flight pattern to protect prioritized peripheral components. In the depicted embodiment, UAV protection program 106 resides on UAV 104. In another embodiment, UAV protection program 106 may reside elsewhere within distributed data processing environment 100, provided that UAV protection program 106 can access one or more controls of UAV 104, as well as database 108, via network 102. In an embodiment where UAV 104 is another type of unmanned or autonomous vehicle, UAV protection program 106 is a substantially similar program that protects the vehicle components based on a prioritization of the components. In an embodiment, UAV protection program 106 includes a machine learning model that is trained with the historical data of any flight failure scenarios, amelioration actions taken by UAV protection program 106, and/or the results of the amelioration actions in association with UAV 104 and/or other unmanned aerial vehicles (not shown).

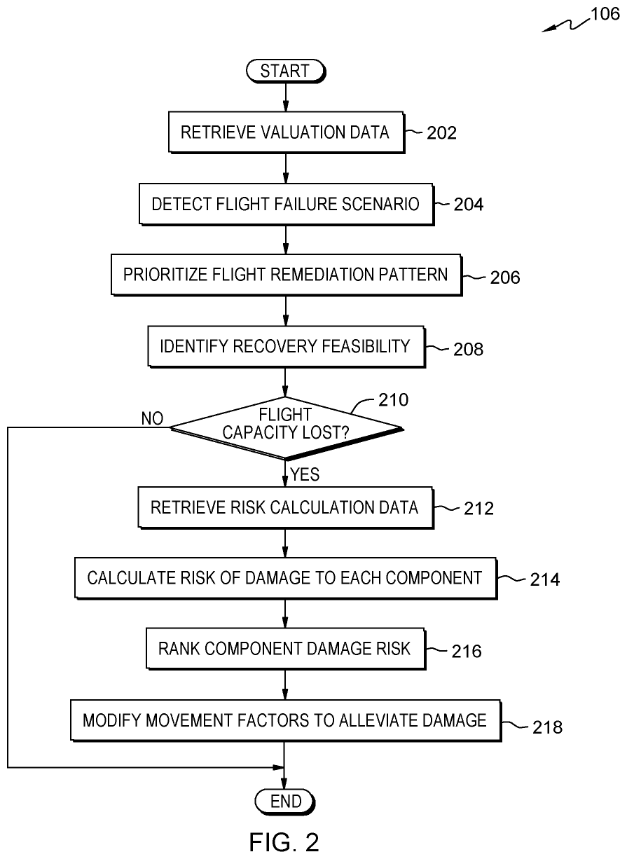

UAV protection program 106 retrieves valuation data. UAV protection program 106 detects a flight failure scenario. UAV protection program 106 prioritizes a flight remediation pattern. UAV protection program 106 identifies recovery feasibility. UAV protection program 106 determines whether flight capacity is lost, and, if so, UAV protection program 106 retrieves risk calculation data. UAV protection program 106 calculates a risk of damage to each component. UAV protection program 106 ranks component damage risk. UAV protection program 106 modifies one or more movement factors to alleviate damage. UAV protection program 106 is depicted and described in further detail with respect to FIG. 2.

In the depicted embodiment, database 108 resides on UAV 104. In another embodiment, database 108 may reside elsewhere within distributed data processing environment 100, provided that UAV protection program 106 has access to database 108, via network 102. A database is an organized collection of data. Database 108 can be implemented with any type of storage device capable of storing data and configuration files that can be accessed and utilized by UAV protection program 106 such as a database server, a hard disk drive, or a flash memory. Database 108 stores information used by and generated by UAV protection program 106. Database 108 stores valuation, priorities, and ranking of each UAV component, as well as any current payload, provided by the user of client computing device 110, via user interface 112. Database 108 also stores metrics associated with UAV 104, such as velocity, speed, and altitude. In addition, database 108 stores UAV 104 component function information. Further, database 108 stores environmental information corresponding to the geographic location of UAV 104 at the time of a flight failure and/or crash. Database 108 may also store amelioration history, i.e., previous actions taken by UAV protection program 106 following a detected failure scenario, as well as the results of the actions, such as detected damage to one or more components and/or the payload of UAV 104.

The present invention may contain various accessible data sources, such as database 108, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. UAV protection program 106 enables the authorized and secure processing of personal data. UAV protection program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. UAV protection program 106 provides information regarding personal data and the nature (e.g., type, scope, purpose, duration, etc.) of the processing. UAV protection program 106 provides the user with copies of stored personal data. UAV protection program 106 allows the correction or completion of incorrect or incomplete personal data. UAV protection program 106 allows the immediate deletion of personal data.

Client computing device 110 can be one or more of a laptop computer, a tablet computer, a smart phone, smart watch, a smart speaker, or any programmable electronic device capable of communicating with various components and devices within distributed data processing environment 100, via network 102. Client computing device 110 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In an embodiment, the wearable computer may be in the form of a smart watch. In one embodiment, the wearable computer may be in the form of a head mounted display (HMD). The HMD may take the form-factor of a pair of glasses, such as augmented reality (AR) glasses, which is a device for viewing mixed reality and/or augmented reality scenarios. In the embodiment where the HMD is a pair of AR glasses, the AR glasses can capture eye gaze information from a gaze point tracker, such as a camera associated with client computing device 110. In general, client computing device 110 represents one or more programmable electronic devices or combination of programmable electronic devices capable of executing machine readable program instructions and communicating with other computing devices (not shown) within distributed data processing environment 100 via a network, such as network 102. Client computing device 110 includes an instance of user interface 112.

User interface 112 provides an interface between UAV protection program 106 on UAV 104 and a user of client computing device 110. In one embodiment, user interface 112 is mobile application software. Mobile application software, or an “app,” is a computer program designed to run on smart phones, tablet computers and other mobile devices. In one embodiment, user interface 112 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In an embodiment, user interface 112 enables a user of client computing device 110 to input data to be used by UAV protection program 106, such as valuation, priorities, and ranking of each UAV component, as well as any current payload. In an embodiment, user interface 112 also enables a user of client computing device 110 to store results of a failure of UAV 104, for example, component damage, or the lack thereof.

FIG. 2 is a flowchart depicting operational steps of unmanned aerial vehicle (UAV) protection program 106, on UAV 104 within distributed data processing environment 100 of FIG. 1, for ameliorating risk to UAV 104, in accordance with an embodiment of the present invention.

UAV protection program 106 retrieves valuation data (step 202). In an embodiment, the user of client computing device 110 stores valuation data associated with various components of UAV 104 in database 108, and UAV protection program 106 retrieves the valuation data from database 108. For example, valuation data may be a cost or price to replace a component if the component is damaged. In another example, valuation data may be a priority and/or ranking data associated with various components of UAV 104 as pre-defined by the user. In addition to the cost/price of replacing a component, the priority may be based on the difficulty of replacing a component. In an embodiment, UAV protection program 106 retrieves valuation data, i.e., a cost or price, of one or more components of UAV 104 from a commercial marketplace (not shown). In an embodiment, UAV protection program 106 retrieves valuation data corresponding to a payload carried by UAV 104 from database 108. In another embodiment, UAV protection program 106 retrieves valuation data of the payload from a commercial marketplace (not shown). In an embodiment, UAV protection program 106 may receive valuation data directly from the user of client computing device 110, via user interface 112.

In an embodiment, UAV protection program 106 may also retrieve one or more relevant environmental risks for any scenario that may impede the overall flight capability of UAV 104 and/or the health of the various components of UAV 104. For example, UAV protection program 106 may retrieve weather forecasts and/or environmental sensor data that can indicate whether a high wind warning or risk of hail are present in the environment.

UAV protection program 106 detects a flight failure scenario (step 204). In an embodiment, sometime after UAV 104 is dispatched on a flight, UAV protection program 106 detects that UAV 104 is beginning to encounter a flight failure scenario. For example, UAV protection program 106 detects via one or more sensors associated with UAV 104 that the altitude of UAV 104 has dropped by an amount greater than a threshold distance in less than a threshold period of time. In another example, UAV protection program 106 detects that one or more of a plurality of propellers of UAV 104 has stopped operating. In an embodiment, upon detection of a flight failure scenario, UAV protection program 106 queries local information for physical peripheral details pertaining to UAV 104 and/or the environment in which UAV 104 is flying and receives data in response to the query. For example, UAV protection program 106 queries the health of the remaining propellers of the plurality of propellers of UAV 104. In another example, UAV protection program 106 queries a current, local weather forecast.

UAV protection program 106 prioritizes a flight remediation pattern (step 206). In an embodiment, based on the retrieved valuation data, the detected failure scenario, and the received response to the local information query, UAV protection program 106 prioritizes a flight remediation pattern by determining actions to take to ameliorate the flight failure. For example, if UAV 104 was programmed to fly at a certain speed and is having issues, then UAV protection program 106 determines whether lowering the flight speed of UAV 104 may correct the problem. In another example, UAV protection program 106 can determine whether changing the direction of the flight path of UAV 104 may correct the problem. In an attempt to ameliorate the flight failure scenario, UAV protection program 106 aggregates data related to various aspects of the scenario, including, but not limited to, the condition of the area underneath UAV 104, one or more environmental risks, ease of access by UAV 104 to the area, and ease of access to retrieve UAV 104 in the area. For example, UAV protection program 106 may identify the topography of the surface below UAV 104, determining whether it is land or water, flat or mountainous, barren or forested, etc. In another example, UAV protection program 106 may determine weather conditions and whether the geographic area is snow-covered or icy.

UAV protection program 106 identifies recovery feasibility (step 208). In an embodiment, based on the available data, UAV protection program 106 determines whether recovery from the flight failure scenario is feasible. UAV protection program 106 may determine whether a partial recovery or a full recovery is feasible. For example, UAV protection program 106 may determine that the flight of UAV 104 can recover from the loss of one propeller if UAV 104 includes a total of eight propellers, but if UAV 104 includes only four propellers, then UAV protection program 106 may determine the flight recovery is not feasible.

UAV protection program 106 determines whether flight capacity is lost (decision block 210). Based on the available data and the determination of whether a partial or full recovery of the flight of UAV 104 is feasible, UAV protection program 106 determines whether the flight capacity of UAV 104 is lost. If UAV protection program 106 determines flight capacity is not lost (“no” branch, decision block 210), then UAV protection program 106 ends execution and UAV 104 continues its route.

If UAV protection program 106 determines flight capacity is lost (“yes” branch, decision block 210), then UAV protection program 106 retrieves risk calculation data (step 212). In an embodiment, if UAV protection program 106 determines a partial or full recovery of the flight of UAV 104 is not feasible, and therefore, the flight capacity of UAV 104 is lost, then UAV protection program 106 retrieves data for use in calculating any risk that a crash of UAV 104 may pose to the peripheral components of UAV 104, and/or to any payload UAV 104 is carrying, and/or to UAV 104 itself. For example, UAV protection program 106 retrieves velocity and speed metrics of UAV 104, such as whether the flight direction is changing. In another example, UAV protection program 106 retrieves altitude metrics of UAV 104, such as whether UAV 104 appears to be falling and, if so, the speed at which UAV 104 is falling. In a further example, UAV protection program 106 retrieves any data reflective of the function and/or health of the peripheral components of UAV 104, such as whether all of the propellers are moving. In an embodiment, UAV protection program 106 also retrieves historical data associated with the flight of UAV 104 to include in the risk calculation data. For example, UAV protection program 106 retrieves data from past flights of UAV 104 to determine whether UAV 104 has had a similar incident in the past. In another example, UAV protection program 106 may retrieve industry data associated with flight failure incidents of other UAVs of the same model and/or manufacturer as UAV 104. In an embodiment, risk calculation data may also include the retrievability of UAV 104 from a projected crash location. For example, UAV protection program 106 predicts whether the crash location is in the middle of an ocean or in a fenced area. In an embodiment, risk calculation data includes data that UAV protection program 106 aggregated with respect to step 206, including, but not limited to, one or more environmental risks, case of access by UAV 104 to the area, case of access to retrieve UAV 104 in the area, etc. For example, risk calculation data may include the topography of the surface below UAV 104, and weather conditions, such as whether the geographic area is snow-covered or icy.

UAV protection program 106 calculates a risk of damage to each component (step 214). In an embodiment, based on the retrieved risk calculation data, UAV protection program 106 calculates a risk of damage to each peripheral component of UAV 104 if the flight failure scenario of UAV 104 is not changed in some way. In an embodiment, UAV protection program 106 also calculates the risk of damage to the payload UAV 104 is carrying. For example, if UAV 104 has a camera on the underside of its body, and UAV protection program 106 determines UAV 104 is falling straight down at a high speed, then UAV protection program 106 can predict the risk of the camera being damaged if it hits a hard surface.

UAV protection program 106 ranks component damage risk (step 216). In an embodiment, based on the calculated risk to each component, UAV protection program 106 ranks the component damage risks from highest risk to lowest risk. In an embodiment, UAV protection program 106 includes the retrieved valuation of each component in the ranking, such that UAV protection program 106 may rank minimal damage to a high-value component higher than catastrophic damage to an inexpensive, easily replaced component. In an embodiment, UAV protection program 106 also includes the valuation of the payload UAV 104 is carrying in the risk ranking.

UAV protection program 106 modifies one or more movement factors to alleviate damage (step 218). In an embodiment, based on the ranking of damage risk to the various peripheral components and/or payload, UAV protection program 106 adjusts the flight pattern of UAV 104 to modify the geographic movement of UAV 104 in an effort to minimize the damage to the highest ranked components in the event of a crash. For example, UAV protection program 106 may alter the flight pattern of UAV 104, such as by changing its speed, to maneuver UAV 104 toward a landing spot in water instead of on concrete, based on the knowledge that UAV 104 has a waterproof housing and that landing on concrete would likely damage the camera. In an embodiment, UAV protection program 106 modifies fall behavior of UAV 104 to change the orientation of the device in an effort to minimize the damage to the highest ranked components in the event of a crash. For example, UAV protection program 106 may cause UAV 104 to flip upside down to protect a component on the underside of UAV 104.

In an embodiment, UAV protection program 106 may employ one or more available countermeasures while UAV 104 is still in the air to ensure the best possible outcome. For example, if UAV 104, or any specific component of UAV 104, is equipped with a parachute, then UAV protection program 106 can deploy the parachute in anticipation of a crash landing. In another example, UAV protection program 106 can deploy an inflatable “bubble” and/or airbag associated with one or more peripheral components and/or payload if UAV 104 is equipped with such technology.

In an embodiment, UAV protection program 106 captures data associated with the landing and/or crash of UAV 104. For example, UAV protection program 106 detects damage to one or more of the components of UAV 104 and/or the payload that UAV 104 was carrying. In another example, UAV protection program 106 may detect the health of one or more components of UAV 104 that are still functioning after a crash. In a further example, UAV protection program 106 captures environmental data, such as wind conditions, precipitation, ground conditions, etc., at the time of a crash. In an embodiment, UAV protection program 106 stores the captured data in database 108. In an embodiment where UAV protection program 106 includes a machine learning component, UAV protection program 106 can compare a predicted outcome of the amelioration actions performed in anticipation of a crash to the data captured after the crash to determine which actions were successful in preventing and/or limiting damage to components of UAV 104 and to learn what additional actions to deploy in a future, similar flight failure scenario.

FIG. 3 is an example diagram of a distributed data processing environment, representative of distributed data processing environment 100 depicted in FIG. 1, in which aspects of one or more of the illustrative embodiments may be implemented, and at least some of the computer code involved in performing the inventive methods may be executed, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Computing environment 300 contains an example of an environment for the execution of at least some of the computer code involved in performing the inventive methods, such as UAV protection program 106 for ameliorating risk to a UAV. In addition to UAV protection program 106, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and UAV protection program 106, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in UAV protection program 106 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid-state storage devices. Operating system 322 may take several forms, such as various known proprietary operating systems or open-source Portable Operating System Interface type operating systems that employ a kernel. The code included in UAV protection program 106 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
retrieving, by one or more computer processors, valuation data corresponding to one or more components of an unmanned aerial vehicle;
detecting, by one or more computer processors, a flight failure scenario of the unmanned aerial vehicle;
prioritizing, by one or more computer processors, a flight remediation pattern of the unmanned aerial vehicle;
identifying, by one or more computer processors, a feasibility of flight recovery;
based on the feasibility of the flight recovery, determining, by one or more computer processors, flight capacity is lost;
retrieving, by one or more computer processors, risk calculation data;
calculating, by one or more computer processor, a damage risk for each of the one or more components using the risk calculation data;
based on the retrieved valuation data and the calculated damage risk, ranking, by one or more computer processors, the damage risk for each of the one or more components; and
based on the ranking, modifying, by one or more computer processors, one or more movement factors of the unmanned aerial vehicle to alleviate damage.

2. The computer-implemented method of claim 1, wherein the one or more components of the unmanned aerial vehicle include a payload carried by the unmanned aerial vehicle.

3. The computer-implemented method of claim 1, wherein the valuation data corresponding to the one or more components of an unmanned aerial vehicle includes: a cost to replace a damaged component, a price to replace the damaged component, a pre-defined priority associated with the damaged component, a pre-defined ranking associated with the damaged component, and a difficulty of replacing the damaged component.

4. The computer-implemented method of claim 1, wherein the risk calculation data includes: a velocity metric, a speed metric, an altitude metric, a change of flight direction, a speed at which the unmanned aerial vehicle is falling, data associated with a function of the one or more components, data associated with a health of the one or more components, historical data associated with a flight of the unmanned aerial vehicle, industry data associated with a model of the unmanned aerial vehicle, industry data associated with a manufacturer of the unmanned aerial vehicle, retrievability of the unmanned aerial vehicle from a projected crash location, an environmental risk, ease of access of an area by the unmanned aerial vehicle, a topography of a projected crash location, and a weather condition.

5. The computer-implemented method of claim 1, further comprising:
querying, by one or more computer processors, local information for details pertaining to a health of the one or more components and to an environment in which the unmanned aerial vehicle is flying; and
receiving, by one or more computer processors, data in response to the query.

6. The computer-implemented method of claim 1, wherein prioritizing the flight remediation pattern of the unmanned aerial vehicle comprises:
aggregating, by one or more computer processors, data associated with one or more aspects of the flight failure scenario; and
determining, by one or more computer processors, one or more actions to take to ameliorate the flight failure scenario.

7. The computer-implemented method of claim 1, wherein modifying the one or more movement factors of the unmanned aerial vehicle to alleviate the damage further comprises:
modifying, by one or more computer processors, a fall behavior of the unmanned aerial vehicle.

8. A computer program product comprising:
one or more computer readable storage media;
program instructions, stored on at least one of the one or more computer-readable storage media, to retrieve valuation data corresponding to one or more components of an unmanned aerial vehicle;
program instructions, stored on at least one of the one or more computer-readable storage media, to detect a flight failure scenario of the unmanned aerial vehicle;
program instructions, stored on at least one of the one or more computer-readable storage media, to prioritize a flight remediation pattern of the unmanned aerial vehicle;
program instructions, stored on at least one of the one or more computer-readable storage media, to identify a feasibility of flight recovery;
based on the feasibility of the flight recovery, program instructions, stored on at least one of the one or more computer-readable storage media, to determine flight capacity is lost;
program instructions, stored on at least one of the one or more computer-readable storage media, to retrieve risk calculation data;
program instructions, stored on at least one of the one or more computer-readable storage media, to calculate a damage risk for each of the one or more components using the risk calculation data;
based on the retrieved valuation data and the calculated damage risk, program instructions, stored on at least one of the one or more computer-readable storage media, to rank the damage risk for each of the one or more components; and
based on the ranking, program instructions, stored on at least one of the one or more computer-readable storage media, to modify one or more movement factors of the unmanned aerial vehicle to alleviate damage.

9. The computer program product of claim 8, wherein the one or more components of the unmanned aerial vehicle include a payload carried by the unmanned aerial vehicle.

10. The computer program product of claim 8, wherein the valuation data corresponding to the one or more components of an unmanned aerial vehicle includes: a cost to replace a damaged component, a price to replace the damaged component, a pre-defined priority associated with the damaged component, a pre-defined ranking associated with the damaged component, and a difficulty of replacing the damaged component.

11. The computer program product of claim 8, wherein the risk calculation data includes: a velocity metric, a speed metric, an altitude metric, a change of flight direction, a speed at which the unmanned aerial vehicle is falling, data associated with a function of the one or more components, data associated with a health of the one or more components, historical data associated with a flight of the unmanned aerial vehicle, industry data associated with a model of the unmanned aerial vehicle, industry data associated with a manufacturer of the unmanned aerial vehicle, retrievability of the unmanned aerial vehicle from a projected crash location, an environmental risk, ease of access of an area by the unmanned aerial vehicle, a topography of a projected crash location, and a weather condition.

12. The computer program product of claim 8, further comprising:
program instructions, stored on at least one of the one or more computer-readable storage media, to query local information for details pertaining to a health of the one or more components and to an environment in which the unmanned aerial vehicle is flying; and
program instructions, stored on at least one of the one or more computer-readable storage media, to receive data in response to the query.

13. The computer program product of claim 8, wherein the program instructions to prioritize the flight remediation pattern of the unmanned aerial vehicle comprise:
program instructions, stored on at least one of the one or more computer-readable storage media, to aggregate data associated with one or more aspects of the flight failure scenario; and
program instructions, stored on at least one of the one or more computer-readable storage media, to determine one or more actions to take to ameliorate the flight failure scenario.

14. The computer program product of claim 8, wherein the program instructions to modify the one or more movement factors of the unmanned aerial vehicle to alleviate the damage comprise:
program instructions, stored on at least one of the one or more computer-readable storage media, to modify a fall behavior of the unmanned aerial vehicle.

15. A computer system comprising:
one or more computer processors;
one or more computer-readable memories; and
one or more computer readable storage media;
program instructions, stored on at least one of the one or more computer-readable storage media for execution by at least one of the one or more computer processors via at least one of the one or more memories, to retrieve valuation data corresponding to one or more components of an unmanned aerial vehicle;
program instructions, stored on at least one of the one or more computer-readable storage media, to detect a flight failure scenario of the unmanned aerial vehicle;
program instructions, stored on at least one of the one or more computer-readable storage media, to prioritize a flight remediation pattern of the unmanned aerial vehicle;
program instructions, stored on at least one of the one or more computer-readable storage media, to identify a feasibility of flight recovery;
based on the feasibility of the flight recovery, program instructions, stored on at least one of the one or more computer-readable storage media, to determine flight capacity is lost;
program instructions, stored on at least one of the one or more computer-readable storage media, to retrieve risk calculation data;
program instructions, stored on at least one of the one or more computer-readable storage media, to calculate a damage risk for each of the one or more components using the risk calculation data;
based on the retrieved valuation data and the calculated damage risk, program instructions, stored on at least one of the one or more computer-readable storage media, to rank the damage risk for each of the one or more components; and
based on the ranking, program instructions, stored on at least one of the one or more computer-readable storage media, to modify one or more movement factors of the unmanned aerial vehicle to alleviate damage.

16. The computer system of claim 15, wherein the one or more components of the unmanned aerial vehicle include a payload carried by the unmanned aerial vehicle.

17. The computer system of claim 15, wherein the valuation data corresponding to the one or more components of an unmanned aerial vehicle includes: a cost to replace a damaged component, a price to replace the damaged component, a pre-defined priority associated with the damaged component, a pre-defined ranking associated with the damaged component, and a difficulty of replacing the damaged component.

18. The computer system of claim 15, further comprising:
program instructions, stored on at least one of the one or more computer-readable storage media, to query local information for details pertaining to a health of the one or more components and to an environment in which the unmanned aerial vehicle is flying; and
program instructions, stored on at least one of the one or more computer-readable storage media, to receive data in response to the query.

19. The computer system of claim 15, wherein the program instructions to prioritize the flight remediation pattern of the unmanned aerial vehicle comprise:
program instructions, stored on at least one of the one or more computer-readable storage media, to aggregate data associated with one or more aspects of the flight failure scenario; and
program instructions, stored on at least one of the one or more computer-readable storage media, to determine one or more actions to take to ameliorate the flight failure scenario.

20. The computer system of claim 16, wherein the program instructions to modify the one or more movement factors of the unmanned aerial vehicle to alleviate the damage comprise:
program instructions, stored on at least one of the one or more computer-readable storage media, to modify a fall behavior of the unmanned aerial vehicle.
